(19) United States
(12) Patent Application Publication
(10) Pub. No.: US 2010/0224045 A1
(43) Pub. Date: Sep. 9, 2010

(54) PUNCH

(75) Inventors: Muneyuki Ishihara, Tokyo (JP); Makoto Mori, Tokyo (JP); Hiroyuki Urabe, Tokyo (JP)

Correspondence Address: OLIFF & BERRIDGE, PLC, P.O. BOX 320850, ALEXANDRIA, VA, 22320-4850, US

(73) Assignee: CARL MFG. CO., LTD., Katsushika-ku, Tokyo (JP)

(21) Appl. No.: 12/670,190

(22) PCT Filed: Jun. 12, 2008
(86) PCT No.: PCT/JP2008/060802

§ 371 Date: Mar. 10, 2010

(30) Foreign Application Priority Data
Jul. 23, 2007 (JP) 2007-191490
Oct. 3, 2007 (JP) 2007-260414

(51) Int. Cl. B26F 1/32; B26D 7/00

(52) U.S. Cl. 83/522.15; 83/630

(57) ABSTRACT

There is provided a punch comprising: a punch blade; a guide passage; a stand that has a flat surface orthogonal to the guide passage, wherein sheets placed on the stand are perforated by operating a handle, and wherein a slit is provided to an upper surface of the stand, a gauge member is slidably inserted into the slit, and the stand and the gauge member are made to be flush. The gauge member is provided with a standing portion, to which an end portion of the sheets is abutted, at one end portion of the gauge member while the gauge member is also provided with a flexible banding member toward the other end portion, wherein the banding member is curved so as to be housed into an interior of the stand.

### TECHNICAL FIELD

The present invention relates to a punch for perforating sheets, especially a punch that is able to achieve accurate performance of a sheet positioning.

### BACKGROUND ART

In punches for office use that have been conventionally used, they comprise: a punch blade; a guide passage; a stand including a flat surface that is orthogonal to the guide passage; and a handle that makes the punch blade moved downward, wherein the punch blade is moved downward by operating the handle while sliding on the guide passage so as to perforate sheets on the stand. In such office-use punches, Japanese Patent Application Laid-Open No. 2006-255830 discloses a punch with a continuous gauge rising up from the side of a sheet stand on which sheets are placed whereby positioning for sheet perforation can be easily set.

In the punch, as shown in FIG. 22, a gauge 120 is drawn out so as to adjust a position to perforate sheets 101. The margin of the sheets 101 is then abutted to a standing portion 130 provided at the tip of the gauge 120. In this condition, a handle is moved downward so as to perforate the sheets 101 at preferable positions.

### Patent Document 1: Japanese Patent Application Laid-Open No. 2006-255830

### DISCLOSURE OF THE INVENTION

### Problem to be Solved by the Invention

However, in the above punch, since the gauge 120 rises up from the lower lateral-portion of a paper stand 103, a step is formed between the drawn-out gauge 120 and the paper stand 103. In case that the margin of the sheets 101 is abutted to the standing portion 130, errors may be produced by the step. Accordingly, it causes problems of that a perforating position of the sheets 101 cannot be accurately set.

The present invention has been made in light of the above problem, and it is an object of the present invention to provide a punch that is able to accurately set a position for perforating sheets.

### Means for Solving the Problem

In order to solve the above problems, the present invention comprises: as recited in Claim 1, a punch blade; a guide passage where the punch blade is guided; a stand including a flat surface that is orthogonal to the guide passage; and a handle that makes the punch blade moved downward, wherein sheets placed on the stand are perforated by operating the handle. Further, as to the main feature of the present invention, a slit is provided at the upper surface of the stand, and a continuous gauge member is slidably inserted into the slit in such a manner that the stand and the gauge member are formed to be flush with each other.

### Effects of the Invention

In the present invention, the slit is provided at the upper surface of the stand on which the sheets are placed, the continuous gauge member is slidably inserted into the slit, and the stand and the gauge member are structured to be flush with each other. Accordingly, no step will be produced between the gauge drawn out from the slit and the stand. Further, since there will be no error due to the step between the gauge and the stand, it is possible to accurately set a position for a sheet perforation.

### BRIEF DESCRIPTION OF THE DRAWINGS

FIG. 1 shows a perspective view of a punch according to the first embodiment of the present invention.

FIG. 2 is an explanatory view showing a condition that an arm is removed from a stand of the punch, and the stand is cut along a slit.

FIG. 3 shows a central section of the punch.

FIG. 4 is a sectional view showing the slit of the stand where (a) indicates a condition before a gauge member is pulled out from the stand, and (b) indicates a condition that the gauge member has been pulled out.

FIG. 5 shows structures of the gauge member where (a) is a plan view, (b) is a sectional view, (c) is a front view, and (d) is a bottom view.

FIG. 6 is an explanatory view presenting relation between fitting recesses of the gauge member and a sheet size.

FIG. 7 shows bellows of the gauge member where (a) is an expanded section taken along line A-A of FIG. 5, and (b) is an expanded section taken along line B-B of FIG. 5.

FIG. 8 shows the most marginal portion of the gauge member where (a) is the perspective view thereof, and (b) is a left side view of FIG. 5.

FIG. 9 is an expanded section mainly showing a condition that the gauge member fitted into the slit is turned toward the interior of the stand.

FIG. 10 is a perspective view showing a modified example of the gauge member.

FIG. 11 is a perspective view showing a modified example of a banded portion of the gauge member where (a) indicates structure that cuneate units are connected one by one with pins, and (b) indicates that the gauge member is structured by means of a flexible banding member.

FIG. 12 is an explanatory view showing a modified example of the gauge member applied to the punch.

FIG. 13 is an explanatory view showing scales provided on the gauge member.

FIG. 14 is an explanatory view showing structure of a punch according to the second embodiment of the present invention.

FIG. 15 is an explanatory view showing a condition that a handle of the punch is slightly pressed down.

FIG. 16 is an explanatory view showing a condition that the handle of the punch is pressed down for perforation.

FIG. 17 is an explanatory view of a first modified example showing how to arrange an axially supporting portion, the handle, a pressing member and a link member in connection with the above punch.

FIG. 18 is an explanatory view of a second modified example showing how to arrange the axially supporting portion, the handle, the pressing member and the link member in connection with the above punch.

FIG. 19 is an explanatory view of a third modified example showing how to arrange the axially supporting portion, the handle, the pressing member and the link member in connection with the above punch.

FIG. 20 is an explanatory view of a fourth modified example showing how to arrange the axially supporting portion, the handle, the pressing member and the link member in connection with the above punch.

FIG. 21 is an explanatory view of a fifth modified example showing how to arrange the axially supporting portion, the handle, the pressing member and the link member in connection with the above punch.

FIG. 22 shows a conventional punch where (a) indicates a condition before a gauge member is pulled out from a stand, and (b) indicates a condition that the gauge member has been pulled out.

### EXPLANATION OF REFERENCE NUMERALS

1 . . . punch, 2 . . . handle, 3 . . . stand, 4 . . . arm, 5 . . . slit, 6 . . . mounting portion, 4 . . . punch blade, 8 . . . guide passage, 9 . . . binding hole, 10 . . . slit, 11 . . . slide surface, 12 . . . projecting portion, 13 . . . guide portion, 14 . . . supporting portion, 20, 20′, 20″ . . . gauge member, 21 . . . gauge main body, 22 . . . rail portion, 25, 26 . . . scale, 27, 28 . . . reference position indication, 30 . . . standing portion, 40, 40′, 40″ . . . banded portion (banding member), 41 . . . bellows, 42 . . . rib portion, 43 . . . cuneate portion, 44 . . . ejection portion, 46 . . . engaging portion, 50 . . . flat portion (plate member), 51 . . . marginal side portion on an upper surface side, 52 . . . marginal side portion 52 on a lower side, 53 . . . engaging concave portion, 55 . . . cavity portion, 60 . . . slide groove, 70 . . . pressing member, 80 . . . link member, and h1, h2 . . . axially supporting portion

### BEST MODES FOR CARRYING OUT THE INVENTION

Preferable embodiments of the present invention will be hereinafter explained with reference to the accompanying drawings. Note that the embodiments should not be limited by the following to be explained, and as long as problems of the present invention are solvable, the other embodiments can be applied. FIG. 1 is a perspective view showing a punch 1 of the first embodiment of the present invention. This punch 1 is a two-hole punch for office use where by pressing down a handle 2, sheets inserted into a slit 5 placed between a stand 3 and an arm 4 can be perforated with two holes.

The arm 4 is for mounting the handle 2 as to be rotative relative to the stand 3, and fixed to a mounting portion 6 provided at each side of the stand 3 by means of a bolt and a nut. At each interior of the arms 4, 4, a punch blade is provided as that a cutting edge thereof is directed downward, the punch blade also allowed for mobility in a vertical direction. This punch blade is energized upward by means of a spring intervening between a flange portion and the stand 3. By pressing the handle 2 downward, the punch blade is shifted downward perforating the sheets.

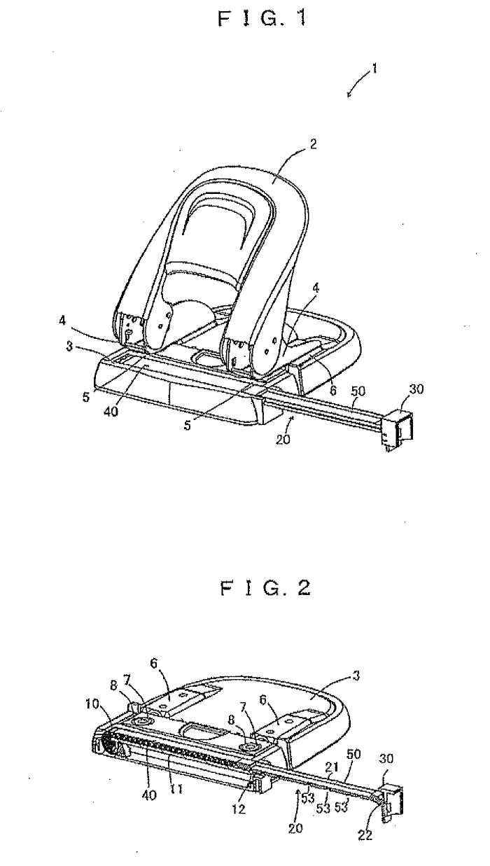

FIG. 2 is an explanatory view where the arm 4 is removed from the stand 3, and further, the stand 3 is cut off along a slit 10 later explained. In the interior of the paper stand 3, a guide passage 8 that guides a punch blade 7 is provided in a direction orthogonal to the upper surface of the stand 3.

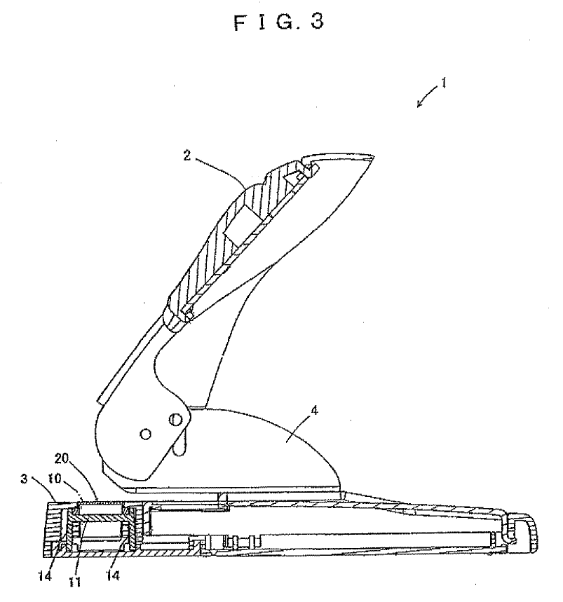

On the upper surface of the stand 3, the slit 10 is provided for installation of a later-explained gauge member 20 in a slidable manner. This slit 10 is a rectangular opening portion having a long side parallel to arrangement of a pair of the punch blades 7, 7. Under the slit 10, a slide surface 11 having a rectangular shape as the same with the slit 10 is provided through a supporting portion 14 (see FIG. 3). This slide surface 11 works as a member where the continuous gauge member 20 is slidably installed within the slit 10 while the end portion of the gauge member 20 is housed in the interior of the stand 3.

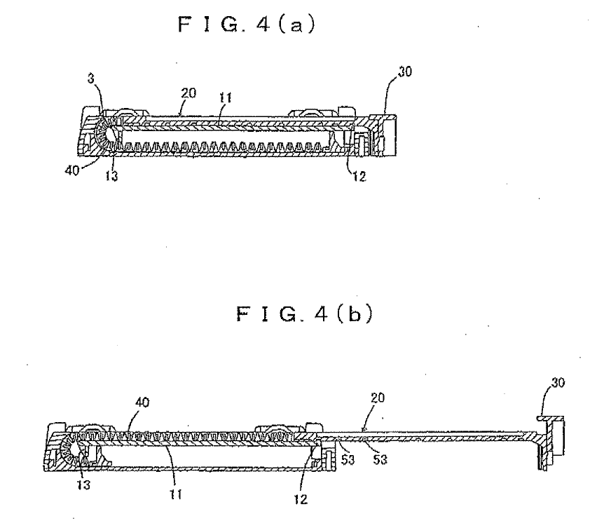

That is, as shown in FIG. 4, the slide surface 11 is horizontally provided at position below the upper surface of the stand 3, shifted down only for thickness of the gauge member 20. Further, one side of the slide surface 11 where the gauge member 20 is drawn out is provided with a projecting portion 12 that projects upward while the other side thereof is provided with a guide portion 13 that projects downward in which to make a later-explained banded portion 40 of the gauge member 20 curved and introduced into the interior of the stand 3. Further, the guide portion 13 also works for fixation of the marginal portion of the gauge member 20. The gauge member 20 is slidably installed into the slit 10 thus structured.

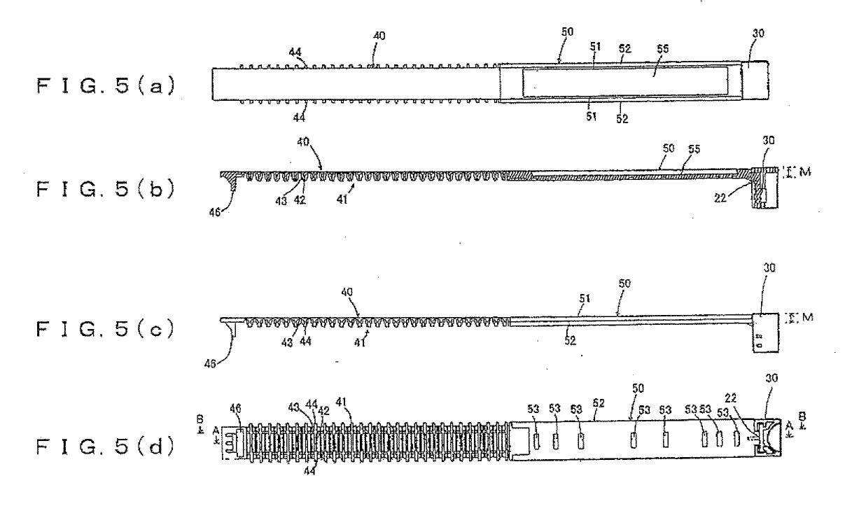

Hereinafter, structure of the gauge member 20 will be explained with reference to FIG. 5. The gauge member 20 is provided with a standing portion 30 on one side thereof and is provided with the flexible banded portion 40 extended toward the other side thereof. The standing portion 30 is a part working to make the margin of the sheets abutted. The standing portion 30 is mounted by engaging a groove portion provided on the interior surface of the standing portion 30 with a rail portion 22 provided on one side of the gauge main body 21. The standing portion 30 can be slid in a vertical direction.

The gauge main body 21 is integrally molded by resinous materials such as polypropylene (PP). The gauge main body 21 has a thick flat portion 50 formed from the one end portion to central portion thereof, and has the flexible banded portion 40 from the central portion to the other side thereof. The flat portion 50 is, as shown in FIG. 5(c), a continuous plate member having a predetermined thickness M. In case the flat portion 50 is mounted on the slit 10, the flat portion 50 is designed that a marginal side portion 51 on the upper surface side of the flat portion 50 becomes flush with the stand 3. At intermediate portion of the upper surface of the flat portion 50, a cavity portion 55 is formed for attachment of seals on which scales or the like are printed. This cavity portion 55 has a proper depth so that when the seals with a predetermined thickness are attached, it is possible to maintain flushness with the marginal side portion 51.

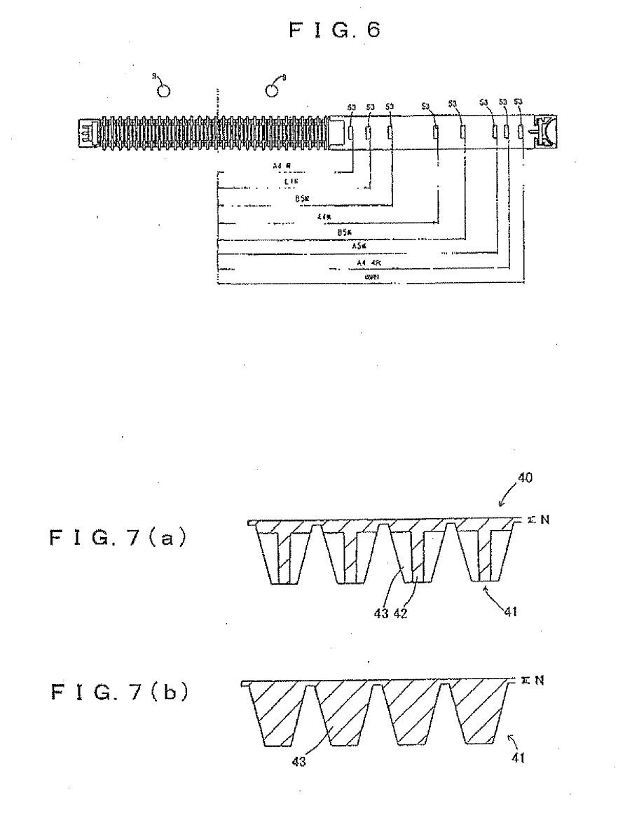

A marginal side portion 52 on the lower side of the flat portion 50 is projected toward the side of the flat portion 50, the marginal side portion 52 being formed in a rail shape. By inserting the marginal side portion 52 between the slit 10 and the slide surface 11, the flat portion 50 becomes slidable. The bottom surface of the flat portion 50 is provided with engaging concave portions 53 at predetermined portions thereof. These engaging concave portions 53 are, as shown in FIG. 6, used when binding holes 9 are formed on the marginal lateral portion of the sheets in a standard size. A plurality of the engaging concave portions 53 are provided according to perforating positions of the standard sheets (for example, portrait A4, LTR size, portrait B5, landscape A4, landscape B5, landscape A5, and A4 with 4 hole).

By engaging the engaging concave portions 53 with the projection portion 12 provided at the slit 10 (see FIG. 4), the gauge member 20 can be fixed to the stand 3. The banded portion 40 placed from the central portion to the other end of the gauge member 20 is provided with bellows 41 in a cuneal section on the lower surface of the banded portion 40, and the upper surface of the banded portion 40 is a smooth surface that is flush with the stand 3.

The bellows 41 placed at the lower surface of the banded portion 40 are provided with rib portions 42 extended in a width direction, the rib portions being continuously formed in a longitudinal direction. At each side of the rib portion 42, as shown in FIG. 7(b), trapezoidal cuneate portions 43 having a long upper base are continuously provided. This cuneate portion 43 in the trapezoidal form is designed to curve the banded portion 40 downward drawing a predetermined trajectory whereby the banded portion 40 can be smoothly housed into the interior of the stand 3. Further, in the cuneate portions 43, thickness N defined between the upper side portion and the upper surface thereof is designed so that the banded portion 40 can be curved in hinge formation.

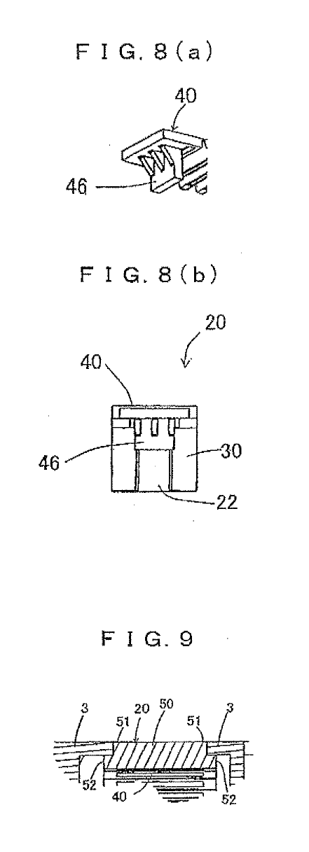

On each marginal side of the banded portion 40, an ejection portion 44 connecting from the rib portion 42 is provided (see FIG. 5). This ejection portion 44 is a part in which to be slidably inserted into a portion defined between the slit 10 of the stand 3 and the slide surface 11. The ejection portion 44 is designed to be placed below the rib portion 42. With this construction, the banded portion 40 can be curved forming bellows. Furthermore, the most end portion of the banded portion 40 is, as shown in FIG. 8, provided with an engaging portion 46 to be engaged with the guide portion 13 of the slide surface 11.

When the gauge member 20 structured as discussed above is installed into the slit 10 of the stand 3, as shown in FIG. 4(b), in a condition where the bellows 41 of the banded portion 40 is directed downward, the gauge member 20 is pushed into the interior of the stand 3 while moving along the slide surface 11, and then the engaging portion 46 placed on the most end of the banded portion 40 is engaged with the back surface of the guide portion 13. In this condition, by sliding the flat portion 50 so as to place it on the upper surface of the slide surface 11, the banded portion 40 is curved while being guided by the guide portion 13 so that the banded portion 40 is housed into the interior of the stand 3. In a condition where the banded portion 40 is housed, as shown in FIG. 9, the flat portion 50 becomes flush with the stand 3, and the banded portion 40 is wound up so as to be housed into the interior of the stand 3.

Working condition of the punch 1 structured as discussed hereinabove will be explained. Based on a condition of FIG. 4 where the gauge member 20 is housed into the interior of the stand 3, the standing portion 30 lifts upward so as to be a standing position. Then, the gauge member 20 is drawn out according to sizes of the sheets, and the engaging concave portion 53 placed at the back side of the gauge member 20 is engaged with the projection portion 12 of the slide surface 11 so as to make the gauge member 20 fixed to the stand 3. Here, since the upper surface of the gauge member 20 is entirely flush with the stand 3, when the sheets are inserted into the slit 5 and placed on the upper surface of the stand 3 and the gauge member 20, the sheets can be prevented from being bended.

In this condition, the handle 2 is operated for perforating the sheets, so that it is possible that holes can be formed at appropriate positions. Especially, since the gauge member 20 is provided with the flexible banded portion 40, and also since this banded portion 40 is housed into the interior of the stand 3 by making the banded portion 40 curved, when the gauge member 20 is drawn out, it is possible to cover up the slit 10 placed at the upper surface of the stand 3 by the banded portion 40 housed in the stand 3.

Accordingly, when the gauge member 20 is drawn out, it is possible to prevent from making an open space on the slit 10 where there was the gauge member 20 that has been housed in the stand 3. Further, since the standing portion 30 to which the end of the sheets is abutted is provided at one end of the gauge member 20, it is possible to easily adjust the sheets by abutting the end thereof to the standing portion 30.

Since the gauge member 20 according to the embodiment of the present invention is integrally molded by resinous materials, it is possible to make the flexible banded portion 40 by making thickness of the materials to be thin into hinge formation. Further, since the thick flat portion 50 is continuously formed from the banded portion 40 of the gauge member 20, when the flat portion 50 having installed within the slit 10 of the stand 3 is pulled out with the standing portion 30, it is possible that the gauge member 20 stays projecting while only one side thereof is hold.

Furthermore, since the banded portion 40 is provided with the bellows 41 that are cuneal in section on the lower surface of the banded portion 40, it is possible to make the banded portion 40 smoothly curved downward, whereby the banded portion 40 can be housed into the interior of the stand 3. In addition, when the banded portion 40 is drawn out from the interior of the stand 3, it is possible that the banded portion 40 draws a smooth trajectory. Still further, since the upper surface of the banded portion 40 is smoothly made, it is possible to reduce friction between the banded portion 40 and the sheets, and to shift the sheets smoothly when adjusting the position of the sheets.

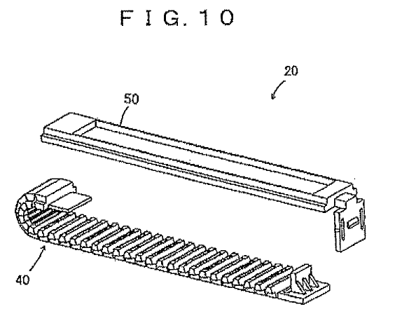

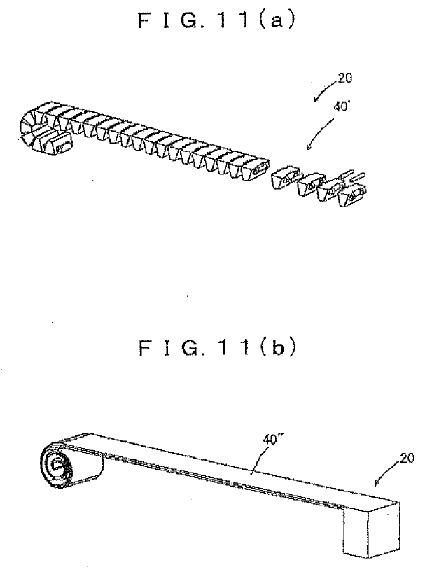

In another embodiment of the banded portion different from what discussed above, as shown in FIG. 10, it is possible to structure the banded portion 40 and the flat portion 50 separately. In this case, it is preferable that the flat portion 50 is made of ABS resin, etc. that has strength and smooth character. Or, as shown in FIG. 11(a), it is possible to structure a banded portion 40′ in such a manner as to sequentially connect each of cuneal body units by means of pins. Further, as shown in FIG. 11(b), it is possible to structure the gauge member 20 in such a manner that a flexible banded portion 40″ in a spring formation is slidably set.

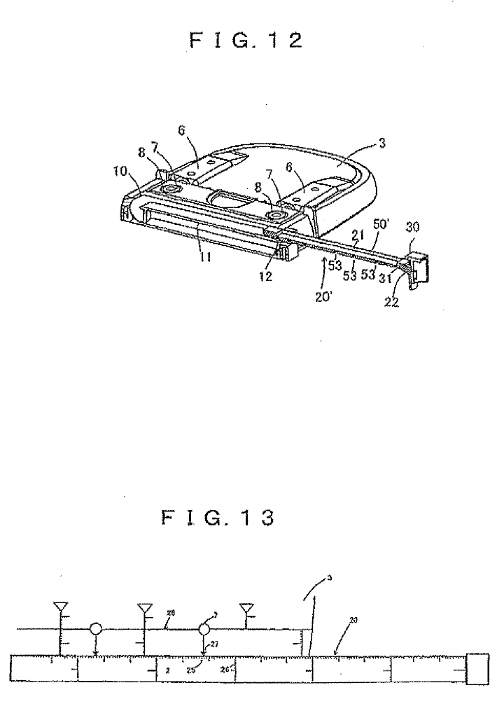

Still further, as shown in FIG. 12, it is possible to structure a gauge member 20″ only by a plate member 50′ that does not have a flexible feature. When the gauge member 20″ is drawn out, opening will be produced at a place where the gauge member 20″ has existed. However, when the sheets are abutted to the standing portion 30, it is still possible to secure horizontality between the margin of the sheets and the perforated position whereby errors of the perforated position due to flexure produced at the margin of the sheets can be restrained.

Moreover, it is possible to provide scales 25, 26 as shown in FIG. 13. In this case, reference position indications 27, 28 may be provided on the stand 3 so as to indicate a perforating position. By setting a distance from the side end of the sheets to the perforated position, or a distance from the front end of the sheets to the perforated position by means of the scales, it is possible to adjust the sheets further accurately.

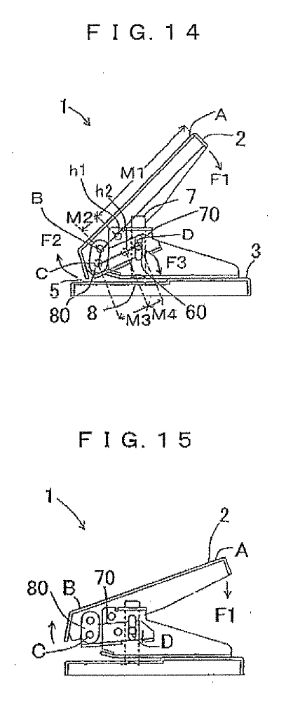

FIG. 4 is an explanatory view showing structure of a punch 1 according to a second embodiment of the present invention. This punch 1 comprises: a stand 3 on which sheets are placed; an arm 4 provided at the stand 3 in an uplifted manner; a handle 2 rotatively provided at the arm 4; a pressing member 70 rotatively provided at the arm 4; a link member 80 connecting the pressing member 70 with the handle 2; a punch blade 7 perforating the sheets; and a guide passage 8 guiding the punch blade 7 so as to perforate the sheet. In FIG. 14, one of the arms 4 of the punch 1 as shown in FIG. 1 is cut along the interior surface of the arm 4 while the punch blade 7 provided in the interior of the arm 4 and movable in a vertical direction is shown by broken lines.

A slit 5 is provided at the upper surface of the stand 3 of the punch 1, and a gauge member not shown is slidably installed into the slit 5. Structures of the stand 3, the slit 5, the punch blade 7, and the guide passage 8 are the same with the punch according to the first embodiment, so that detail explanations thereof will be omitted. At the pair of the arms 4 provided on each side of the stand 3, there are provided axially supporting portions h1, h2 at upper side and lower side of the arm 4. The handle 2 is rotatively provided at the axially supporting portion h1 placed on the upper side of the arm 4 while the pressing member 70 is also rotatively provided at the axially supporting portion h2 placed at the lower side of the arm 4. The handle 2 positioned upward is a member to perform perforating operation by pressing down one end portion A of the handle 2. The handle 2 is pivotally mounted at each of the arms 4 in an oscillating manner through the axially supporting portion h1 deviating from the other end portion B of the handle 2 only by a predetermined distance M2.

The pressing member 70 placed downward is a member for pressing the punch blade 7 downward where the punch blade 7 is rotatively supported by a blade supporting portion provided at one end portion D of the pressing member 70. The portion defined between the other end portion C of the pressing member 70 and the other end portion B of the handle 2 is connected by the link member 80. The pressing member 70 is provided with a slide portion allowing vertical motion by slidably touching a slide groove 60 provided at the arm 4. Accordingly, the punch blade 7 can be smoothly moved in a vertical motion.

Length or a mounting condition of the handle 2, the pressing member 70 and the link member 80 are designed as that a distance M2 defined between the axially supporting portion h1 and the other end portion B is smaller than a distance M3 defined between the axially supporting portion h2 and the other end portion C of the pressing member 70, for example, one half of the distance M3. A distance M1 defined from one end portion A to the axially supporting portion h1 of the handle 2 is designed to be larger than a distance M2 defined from the other end portion, according to desired control force. Further, a distance M4 defined from one end portion D to the axially supporting portion h2 of the pressing member 70 is designed to be smaller than a distance M3 from the other end portion C, according to desired pressing force.

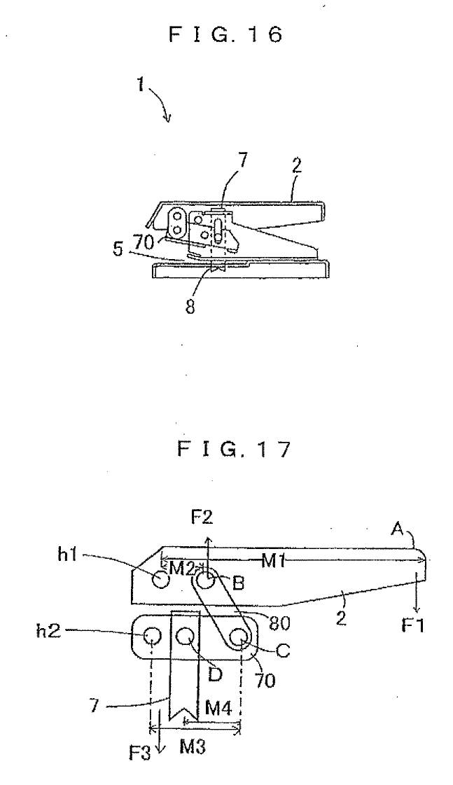

Working condition of the punch 1 structured as discussed above will be explained. In an initial condition as shown in FIG. 14, the sheets to be perforated are inserted into the slit 5. Then, as shown in FIG. 15, one end portion A of the handle 2 is pressed downward. Accordingly, the other end portion C of the pressing member 70 is lifted upward through the link member 80. As shown in FIG. 16, at one end portion D, the punch blade 7 is pressed downward whereby the sheets inserted into the slit 5 are perforated through associated action between the edge of the punch blade and the upper marginal portion of the guide passage 8.

Here, relation between control force F1 applied to one end portion A of the handle 2 and force F2 acted by the other end portion B can be expressed by a formula F1×M1=F2×M2. On the other hand, by lifting up the other end portion B of the handle 2 upward, upward force F2 is applied to the other end portion C of the pressing portion through the link member 80. Through the upward force F2, predetermined pressing force F3 is applied to the punch blade 7. Relation of force in this case can be expressed by a formula F2×M3=F3×M4.

Based on the above, for example, by setting a ratio between the distance M1 from one end portion A of the handle 2 and the distance M2 from the other end portion B to 6:1, and by setting a ratio between the distance M3 from the other end portion B of the handle 2 and the distance M4 from one end portion D to 2:1, it is possible to achieve operations by force of approximately one twelfth (that is, F1) of pressing force of the punch blade 7 (that is, F3). Accordingly, since it is possible to achieve operations through a half of force of a normal lever (that is, F2), control force can be greatly reduced.

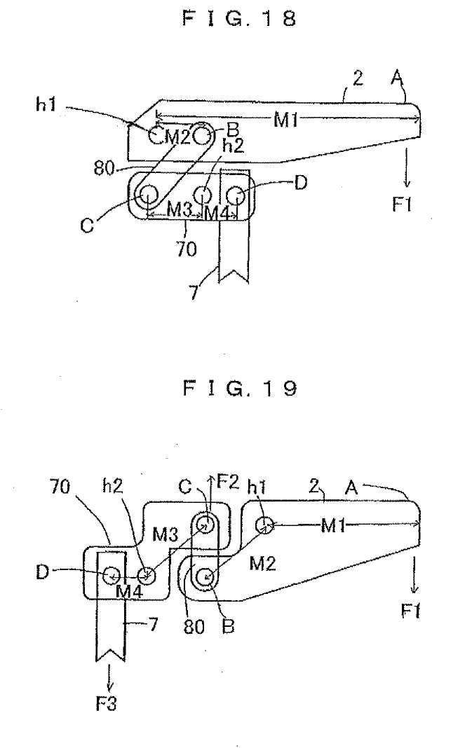

Here, in the punch 1 of the present embodiments, based on the position of the axially supporting portion h1, h2 provided at the arm 4, the handle 2, the pressing member 70 and the link member 80 can be optionally designed as that the distance M2 defined between the axially supporting portion h1 and the other end portion B of the handle 2 is smaller than the distance M3 defined between the axially supporting portion h2 and the other end portion C of the pressing member 70. As to an arranging condition of the axially supporting portion, the handle, the pressing member and the link member of the embodiments of the present embodiments, it should be that a distance M2 defined between the axially supporting portion h1 and the connecting portion B of the handle 2 is smaller than a distance M3 defined between the axially supporting portion h2 and the connecting portion C of the pressing member 70. That is, for example, these may be the first modified example shown in FIG. 17, the second modified example shown in FIG. 18, or the third modified example shown in FIG. 19.

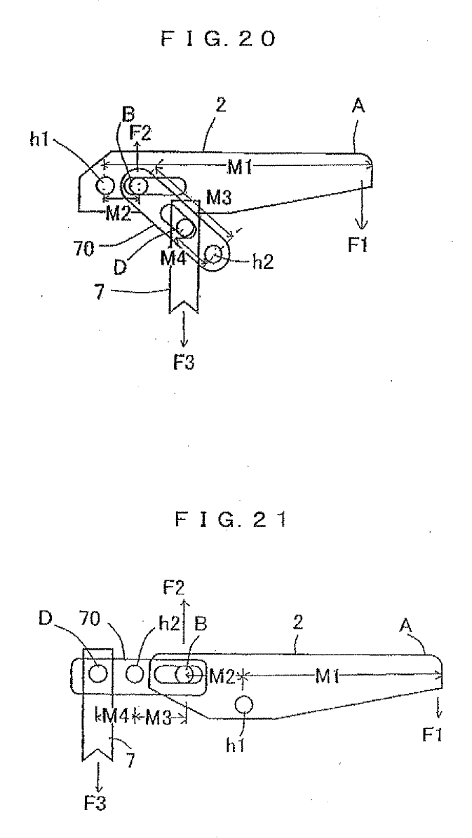

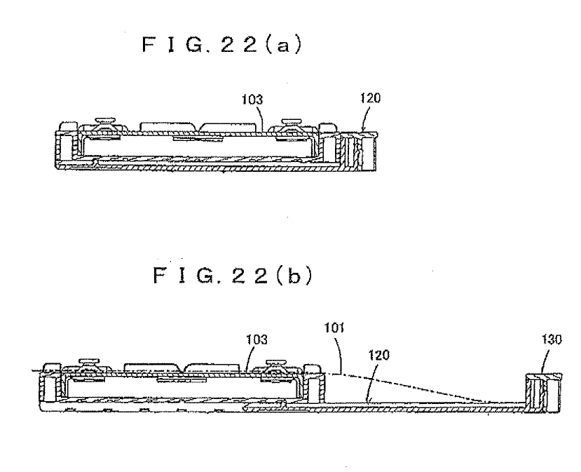

Further, as to an arranging condition of the axially supporting portion, the handle, the pressing member, and the link member, while the pressing member 70 and the handle 2 are connected with each other, a distance M2 defined between the axially supporting portion h1 and the connecting portion B of the handle 2 is smaller than a distance M3 defined between the axially supporting portion h2 and the connecting portion B of the pressing member 70. Accordingly, an embodiment like the fourth modified embodiment shown in FIG. 20 or an embodiment like the fifth modified embodiment is applicable.

In each of the cases, relation between control force F1 applied to a control portion A of the handle 2 and force F2 applied by the connecting portion B can be expressed by a formula F1×M1=F2×M2, and force F3 where the force F2 of the connecting portion B of the handle 2 acts on a pressing portion D of the pressing portion 70 through the link member 80 can be expressed by a formula F3=F2×M3÷M4. Accordingly, for example, in case that ration between a distance M1 from an operation portion A of the handle 2 and a distance M2 from the connecting portion B is set to 6:1 while ration between a distance M3 from a connecting portion C (or B) of the handle 2 and a distance M4 from the pressing portion D is set to 2:1, it is possible to achieve operations by force F1 that is approximately one half of the force (that is, F3) which presses down processing tools.

### INDUSTRIAL APPLICABILITY

The present invention is applicable to a punch used in any fields such as offices, crafts, and industries.

1. A punch comprising: a punch blade; a guide passage by which the punch blade is guided; a stand that has a flat surface orthogonal to the guide passage; a handle that makes the punch blade moved downward, wherein sheets placed on the stand are perforated by operating the handle, a slit is provided on an upper surface of the stand, a continuous gauge member is slidably inserted into the slit, and the stand and the gauge member are made to be flush to each other, and
wherein the gauge member is provided with a standing portion, to which a margin of the sheets is abutted, at one end portion of the gauge member, and the gauge member is also provided with a flexible banding member extending toward the other end portion of the gauge member, wherein the banding member is curved so as to be housed into an interior of the stand.

2. (canceled)

3. The punch according to claim 1 wherein the gauge member is provided with a continuous plate member placed between the stand and the banding member as being flush with the stand.

4. The punch according to claim 1 wherein the banding member has bellows formed into cuneal form in section at a lower surface of the banding member while an upper surface of the banding member is made to be a flat surface.

5. The punch according to claim 4, wherein the banding member is integrally molded by resinous material.

6. The punch according to claim 1, wherein the gauge member is provided with scales at the upper surface thereof.

7. The punch according to claim 1, wherein an arm provided on the stand in an uplifted manner is rotatively provided with the handle that performs perforation at one end portion of the arm while the arm is also rotatively provided with a pressing member that presses the punch blade at one end of the arm,
a link member is provided so as to connect the other end portion of the pressing member with the other end portion of the handle, and
a distance between an axially supporting portion and the other end portion of the handle is set to be smaller than a distance between an axially supporting portion and the other end portion of the pressing member.

8. The punch according to claim 1, wherein an arm provided on the stand in an uplifted manner is rotatively provided with the handle and a pressing member that presses the punch blade, a link member is provided so as to connect the pressing member and the handle by each of the connecting portions thereof, and a distance between an axially supporting portion and the connecting portion of the handle is set to be smaller than a distance between an axially supporting portion and the connecting portion of the pressing member.

9. The punch according to claim 1, wherein an arm provided on the stand in an uplifted manner is rotatively provided with the handle and a pressing member that presses the punch blade, the pressing member and the handle are connected with each other, and a distance between an axially supporting portion and the connecting portion of the handle is set to be smaller than a distance between an axially supporting portion and the connecting portion of the pressing member.
